(19) United States
(12) Patent Application Publication
(10) Pub. No.: US 2010/0101534 A1
(43) Pub. Date: Apr. 29, 2010

(54) MULTIPLE-FUEL ROTARY ENGINE

(76) Inventor: TZU-WEI YU, Kaohsiung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/258,456

(22) Filed: Oct. 27, 2008

(51) Int. Cl. F16J 1/24

(52) U.S. Cl. 123/45 R; 123/575

(57) ABSTRACT

A multiple-fuel rotary engine includes a cylinder seat, a cylinder body, pistons, an intake/exhaust regulation module, a cover, and a top lid. The cylinder body has bores receives the pistons therein and when the cylinder body carries the pistons to rotate, making gas holes thereof positioned under an intake channel, the gas holes are first set in communication with a first sub-channel of the intake channel and then the second sub-channel, whereby two fuel supply systems respectively and sequentially supply two different fuels into the same bore to complete an intake stroke of two different air-fuel mixtures. Combustion of the air-fuel mixtures in the bore provides explosion energy that drives the piston outward to complete the operation of the engine.

### TECHNICAL FIELD OF THE INVENTION

The present invention generally relates to a multiple-fuel rotary engine, and particularly to a simple-construction and high-efficiency multiple-fuel rotary engine that comprises a cylinder body rotatable about a fixed point within an elliptic track recess and an intake/exhaust regulation module including a partition tab that extends into an intake channel and divides an internal space of the intake channel into two sub-channels of which the volumes are variable with movement of the partition tab so as to adjust intake ratio between two mixtures of air and two different fuels that are fed from the two sub-channels into bores of the cylinder body for generation of explosion energy to drive, in an outward direction, pistons movable inside the bores to complete a cycle of intake, compression, power, and exhaust strokes.

### DESCRIPTION OF THE PRIOR ART

Known techniques, such as U.S. Pat. No. 6,230,670 to Robert L. Russell features a cylinder body defining therein a recess for forming a track for the installation of a shaft of the cylinder body whereby the recess guides the reciprocal motion of the shaft to form a rotary engine. However, the recess of the cylinder body of the known patent is of a great length and is curved, whereby loss of the inertial of motion of the shaft and pistons may occur. Further, the construction of the known patent is composed of a great number of parts and is complicated, making it difficult to reduce the costs for manufacturing and maintenance and also hard to simplify the operation of manufacturing and maintenance.

Further, U.S. Pat. No. 686,801 to A. F. Box et al. provides a circular track for a piston and having a circular surface that is provided with multiple sealing strips to ensure a sealing condition of the piston thereby providing a rotary engine. However, such a patent does not provide any cooling or lubricating device to facilitate the operations of the circular track, the cylinder, and the piston, whereby when the piston undergoes repeated reciprocal motion, the circular track, the cylinder, and the piston are not provided with excellent cooling and lubrication, leading to over-heating or even explosion. Further, such a known patent uses mechanical elements, including a spring bar, and such mechanical elements are subject to fatigue for long term operation. Apparently, such a known device is of a flaw design and is not capable to realize rotation.

Other known techniques, such as U.S. Pat. No. 5,343,832 to Jerome L. Murray, U.S. Pat. No. 6,016,737 to Gunnar Lei Jonberg, U.S. Pat. No. 6,161,508 to Karl-Enik Linblad, U.S. Pat. No. 5,3357,911 to Karl-Enik Linblad, U.S. Pat. No. 4,951,618 to Zade Wilson, U.S. Pat. No. 3,604,406 to Michel Hottelet, U.S. Pat. No. 1,646,695 to Lloyd B. Hubbard, U.S. Pat. No. 1,112,338 to P. G Tacchi, and U.S. Pat. No. 1,088,623 to G. L. Ragot, and Japanese Patent No. 60043127 to Katsuhide A. Okamoto, and German Patent No. 3531208 A1 to Lorenz Fetzer, all discloses rotary engines. However, such known techniques all use connection elements and spring elements of various forms to realize rotation. Using such elements increases the overall size of the engine, making risk of part failure during operation increased, which in turn makes it not possible to reduce the manufacturing costs and difficult to assemble and maintain.

Thus, the present invention provides a multiple-fuel rotary engine that features stable output of high power, simple construction, and easy maintenance and may be operated with two different fuels, whereby the purposes of reduction of manufacturing costs and reduction of fuel consumption can be realized.

### SUMMARY OF THE INVENTION

Thus, an objective of the present invention is to provide a multiple-fuel rotary engine that has a simple construction and is operable with two different fuels in order to overcome the above problems of the conventional devices.

In accordance with the present invention, a multiple-fuel rotary engine is provided, comprising a cylinder seat, a rotatable cylinder body, pistons, an intake/exhaust regulation module, a cover, and a top lid. The cylinder seat forms a substantially elliptic recess having an elliptic side surface defining an elliptic track and has a bottom defining centrally a through hole for receiving a shaft therein. The bottom of the cylinder seat also forms an in-flow opening and an out-flow opening, and a drain hole is also defined to extend to outside through a circumferential wall that delimits the track recess. The cylinder body is substantially cylindrical and forms the shaft received in the through hole defined in the track recess. The cylinder body has a circumference in which two circular bores that are set in proper locations and extend horizontally outward along parallel horizontal axes to be substantially corresponding to each other for respectively and movably receiving the pistons therein. Each bore forms a gas hole extending through top side wall thereof, and the gas holes is movable with rotation of the cylinder body to selectively communicate with an ignition opening and intake and exhaust channels defined in the intake/exhaust regulation module. Each bore also forms, in the top wall thereof at a location close to an outer end of the bore, a retention hole that receives and retains a bolt extending downward into a guide slot defined in a top side surface of a piston associated with the bore. Each piston forms a plurality of circumferential airtight sealing strips on an inner end portion thereof and a horizontal recess in an outer end portion thereof. The recess receives therein a horizontal roller, and the top side surface of the piston defines the guide slot above the recess of the piston. The intake/exhaust regulation module comprises a bearing-based seat, a gas communication seat, a regulation plate, and an airtight sleeve, wherein the bearing-based seat is fit over a circumference of a raised cylindrical block of the cylinder body; the gas communication seat is set on the bearing-based seat and has a top wall defining therethrough the ignition opening and also forms the intake channel that is arc in shape and the exhaust channel; the gas communication seat also defines in a center of the top wall thereof an inner-threaded hole that receives and engages a bolt to attach the regulation plate to the gas communication seat; the regulation plate has a sector shape corresponding to and shielding the intake channel; the regulation plate forms two through holes and a partition tab that is provided at a bottom surface of the regulation plate between the through holes for being vertically fit into and snugly engageable with the intake channel to divide the intake channel into two sub-channels; and the airtight sleeve is fit around an outer circumference of the raised cylindrical block of the cylinder body. The cover is secured to the top of the cylinder seat by bolts and forms a central hole that receives the airtight sleeve therein with the top lid further secured thereto. The top lid is secured to the hole of the cover by bolts and forms a vertically extending hollow cylindrical portion that has an inward flange depressing and fixing top surfaces of the gas communication seat and the airtight sleeve. The cylinder body is rotatable within the elliptic track recess with the pistons moving along the elliptic side surface of the track recess by means of the rollers thereof. The partition tab of the intake/exhaust regulation module divides an internal space of the intake channel into the two sub-channels having volumes variable with movement of the partition tab to adjust intake ratio between two mixtures of air and two different fuels that are fed into the bores for generation of explosion energy to drive the pistons outwards, causing rotation of the cylinder body to complete a cycle of intake, compression, power, and exhaust strokes.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a multiple-fuel rotary engine constructed in accordance with the present invention.

FIG. 2 is a cross-sectional view illustrating a cylinder body of the multiple-fuel rotary engine of the present invention, which forms two bores.

FIG. 3 is a perspective view of a gas communication seat of the multiple-fuel rotary engine of the present invention, illustrating an intake channel.

FIG. 4 is also a perspective view of the gas communication seat of the multiple-fuel rotary engine of the present invention, illustrating an exhaust channel.

FIG. 5 is a plan view illustrating an operation condition of the multiple-fuel rotary engine of the present invention.

FIG. 6 is a cross-sectional view taken along line 6-6 of FIG. 5.

FIG. 7 is a plan view illustrating another operation condition of the multiple-fuel rotary engine of the present invention.

FIG. 8 is a cross-sectional view taken along line 8-8 of FIG. 7.

FIG. 9 is a plan view illustrating a multiple-fuel rotary engine constructed in accordance with another embodiment of the present invention, in which the cylinder body forms four bores.

FIG. 10 is a plan view illustrating a multiple-fuel rotary engine constructed in accordance with a further embodiment of the present invention, wherein a track recess is elongated to extend a power stroke of the engine for providing improved rotary power.

FIG. 11 is a schematic cross-sectional view illustrating a practical application of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

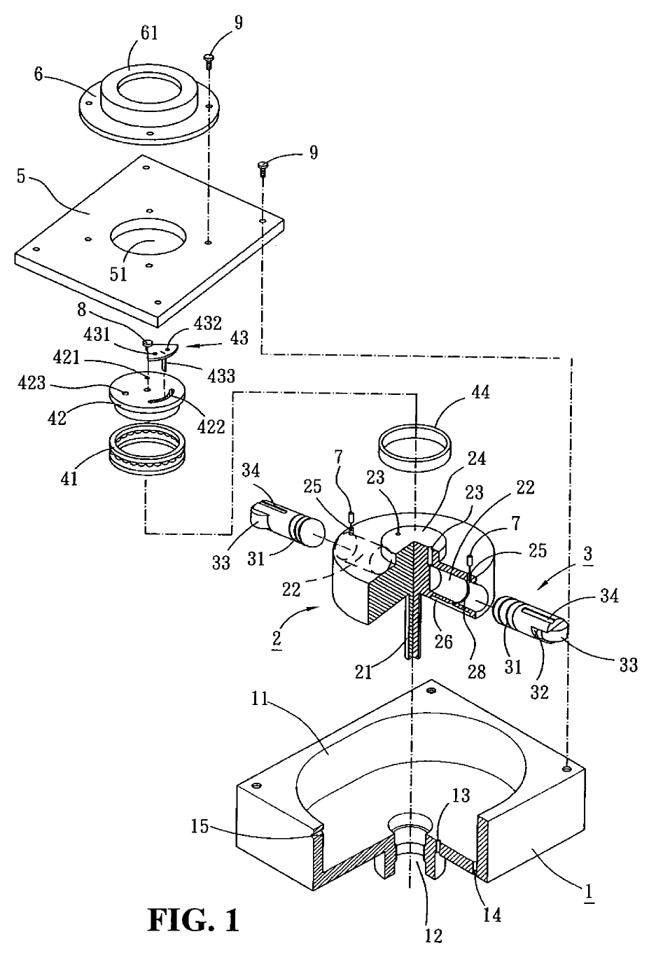

With reference to FIGS. 1-4, a multiple-fuel rotary engine constructed in accordance with the present invention comprises a cylinder seat 1, a rotatable cylinder body 2, pistons 3, an intake/exhaust regulation module 4, a cover 5, and a top lid 6.

The cylinder seat 1 forms a top-open, substantially elliptic recess 11 having an elliptic side surface defining an elliptic track. In a bottom of the track recess 11, a through hole 12 is centrally defined for receiving a vertically-extending shaft 21 therein. The bottom of the track recess 11 also forms an in-flow opening 13 and an out-flow opening 14. A drain hole 15 extending to outside is defined through a circumferential wall that delimits the track recess 11 close to the top opening of the track recess 11.

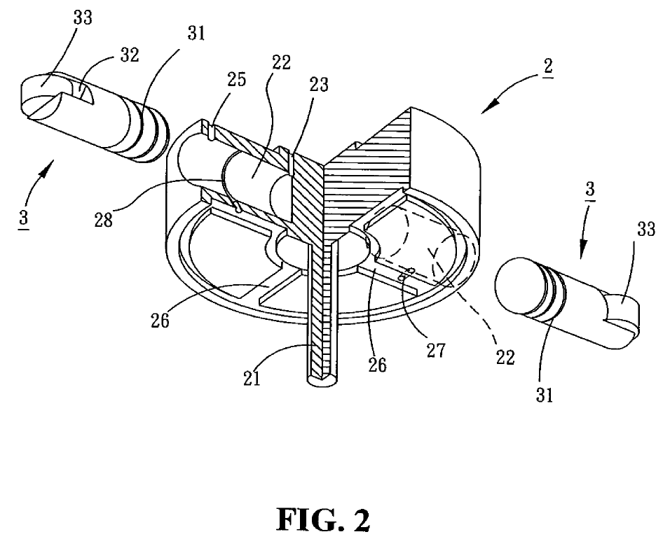

The cylinder body 2, which is substantially cylindrical and forms the shaft 21, defines two circular bores 22 in a circumference thereof that are set in proper locations and extend horizontally outward along parallel horizontal axes to be substantially corresponding to or coaxial with each other. Each bore 22 receives therein a piston 3. Inside the bore 22, a gas hole 23 is defined in and extends through a top side wall thereof and the two gas holes 23 of the bores 22 extend through a centrally-located raised cylindrical block 24. The top wall of each bore 22 also forms, at locations close to an outer end of the bore 22, a retention hole 25 that receives the insertion, preferably in a threading engagement, of a bolt 7 extending downward into a guide slot 34 defined in a top side surface of the associated piston 3. The cylinder body 2 forms in an undersurface thereof a plurality of radially-extending grooves 26 (as shown in FIG. 2), and a through hole 27 is defined in the grooves 26 at a location corresponding to each bore 22 to communicate a circumferential inner slit 28.

Each piston 3 forms a plurality of circumferential airtight sealing strips 31 on an inner end portion thereof and a horizontal recess 32 in an outer end portion thereof. The recess 32 extends transversely to receive therein a horizontal roller 33 that is rotatable about a vertical axis for rolling on the elliptic track surface of the track recess 11. As mentioned above, the top side of the piston 3 defines a guide slot 34 that corresponds to the retention hole 25 of the associated bore 22, whereby the bolt 7 threadingly engages and extends through the retention hole 25 and further down into the guide slot 34 defined in the top side of the piston 3.

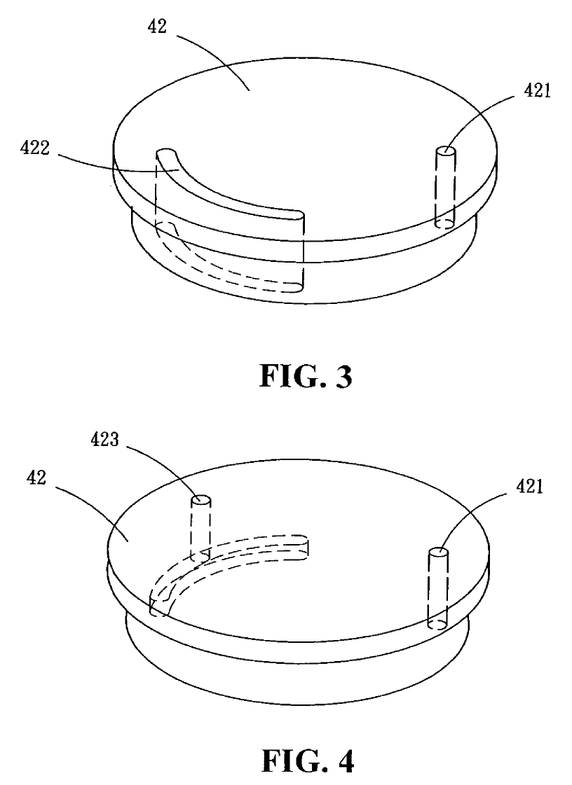

The intake/exhaust regulation module 4 comprises a bearing-based seat 41, a gas communication seat 42, a regulation plate 43, and an airtight sleeve 44. The bearing-based seat 41 is fit over a circumference of the raised cylindrical block 24 of the cylinder body 2 to isolate the rotation of the cylinder body 2. The gas communication seat 42 is set on the bearing-based seat 41 and has a top wall defining therethrough an ignition opening 421 that has an outer end connectable with a known ignition system (not shown). The ignition opening 421 is selectively communicating with the gas holes 23 of the cylinder body 2. Further, the top wall of the gas communication seat 42 also forms, at a suitable location, an intake channel 422 that is arc in shape and extends vertically and completely through the gas communication seat 42 (see FIG. 3). The gas communication seat 42 also has a bottom surface, which forms, at a suitable location, an arc recess that extends upwards and has an inside top surface from a center of which a circular hole is formed and further extending upward through the gas communication seat 42 to define, as a whole, an exhaust channel 423 (see FIG. 4). The arc intake channel 422 and the arc exhaust channel 423 are set in such a way to form, together, a semi-circular arrangement that corresponds to a circular path along which the two gas holes 23 of the cylinder body 2 move to effect intake and exhaust. The gas communication seat 42 also defines in a center of the top wall thereof an inner-threaded hole (not labeled) that receives and engages a bolt 8 to rotatably attach the regulation plate 43 to the gas communication seat 42. The regulation plate 43 is made in the form of a circular sector having a fan shape and forms two through holes 431, 432 and a partition tab 433 that is provided at a bottom surface of the regulation plate 43 between the through holes 431, 432. The partition tab 433 is vertically fit into and is snugly engageable with the intake channel 422 so as to divide the intake channel 422 into two sub-channels 422A, 422B. By loosening the bolt 8, the regulation plate 43 is rotatable with respect to the gas communication seat 42 to vary the internal volumes of the two sub-channels 422A, 422B to adjust the intake ratio between two mixtures of air and two different fuels that are fed into the bores 22 through the two sub-channels 422A, 422B. The fan-shape of the regulation plate 43 is sized to completely shield the intake channel 422 with the two through holes 431, 432 respectively in communication with two sub-channels 422A, 422B. The two through holes 431, 432 are externally and respectively connectable to known fuel supply systems (not shown). The airtight sleeve 44 is of a cylindrical configuration and is fit around the outer circumference of the raised cylindrical block 24 of the cylinder body and completely encloses the bearing-based seat 41 and the gas communication seat 42 therein.

The cover 5 is a flat plate that is secured to the top of the cylinder seat 1 by bolts 9 to seal and close the cylinder body 2. The cover 5 forms a central hole 51 that receives the airtight sleeve 44 therein with the top lid 6 further secured thereto.

The top lid 6 is secured to the hole 51 of the cover 5 by bolts 9 and forms a vertically extending hollow cylindrical portion 61 having an upper end forming an inward flange 611 that depresses and fixes top surfaces of the gas communication seat 42 and the airtight sleeve 44.

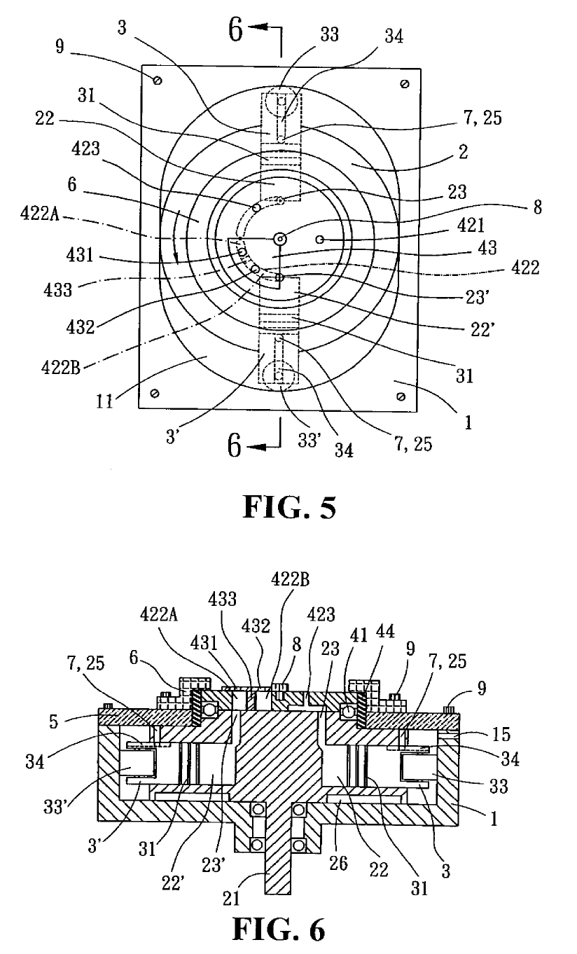

Also referring to FIGS. 5 and 6, when the pistons 3, 3′ are respectively located at upper and lower extreme positions of the track recess 11, the gas holes 23, 23′ of the bores 22, 22′ are respectively at locations below the exhaust channel 423 and intake channel 422. When the cylinder body 2 angularly advance counterclockwise, the gas hole 23′ gradually departs from the sub-channel 422B of the intake channel 422 to exhibit a blocked condition, wherein the internal volume of the bore 22′ is now full of a mixture of two different fuels that are respectively supplied from the two external fuel supply systems. With further counterclockwise advancing, the fuel mixture is gradually compressed by the pistons 3′ to a compressed condition, this being a compression stroke. Meanwhile, the gas hole 23 of another bore 22 is displaced to reach a location exactly below the exhaust channel 423 so that the gas hole 23 and the circular hole of the exhaust channel 423 communicate each other. When the pistons 3 moves inward, exhaust gas that fills the bore 22 is compressed and thus expelled by the pistons 3 to exhaust through the circular hole of the exhaust channel 423, this being an exhaust stroke.

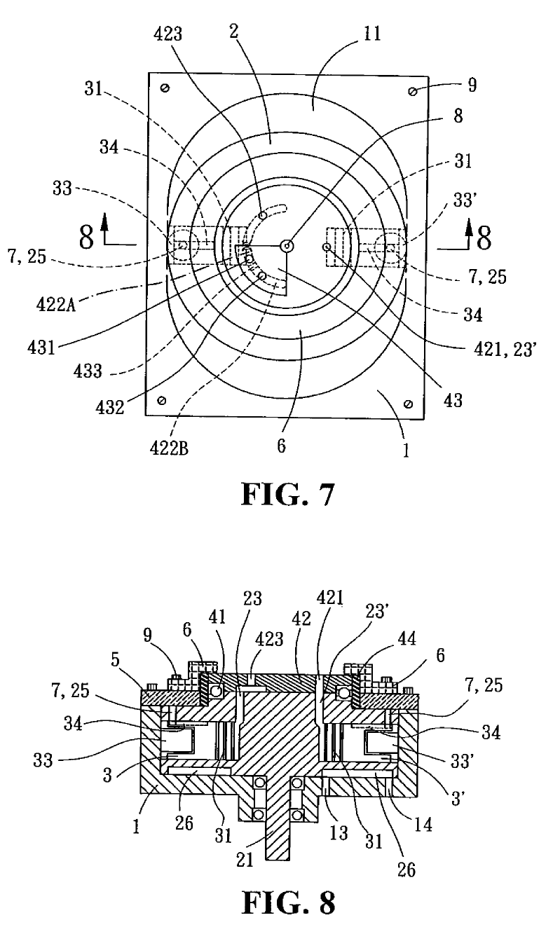

Also referring to FIGS. 7 and 8, when the cylinder body 2 brings the pistons 3, 3′ to the left and right extreme positions of the track recess 11 and continues advancing, the gas hole 23′ is set in communication with the ignition opening 421 of the gas communication seat 42, whereby the ignition system ignites the combustion of the fuel mixture that has been compressed inside the bore 22′ to generate explosion energy that drives the pistons 3′ outward, this being a power stroke. When the pistons 3 is moved with the cylinder body 2 away from the left extreme position, a partial vacuum is induced inside the bore 22. With the through hole 431 connected to a fuel supply system, the fuel supply system supplies a mixture of air and a first fuel that is fed through the through hole 431, the sub-channel 422A, and the gas hole 23 into the internal volume of the bore 22, making the internal volume of the bore 22 initially filled with the mixture of air and first fuel. When the bore 22 is continuously advanced, the gas hole 23 is moved away from the sub-channel 422A toward the sub-channel 422B. The gas hole 23 is now blocked by the partition tab 433 and is no longer in communication with sub-channel 422A and instead becomes in communication with the sub-channel 422B and the through hole 432 above the sub-channel 422B, whereby the internal volume of the bore 22 further receive a mixture of air and a second fuel from another fuel supply system through the sub-channel 422B and the through hole 432. These two fuel mixtures are supplied through the two sub-channels 422A, 422B to the same bore 22 until the pistons 3 moves to the lower extreme position of the track recess 11, where the gas hole 23 gradually leaves the sub-channel 422B and shows a blocked condition, this being an intake stroke. In this way, the pistons 3 may further advance and sequentially undergoes the compression stroke, the power stroke, and the exhaust stroke, to thereby complete the operation of the present invention.

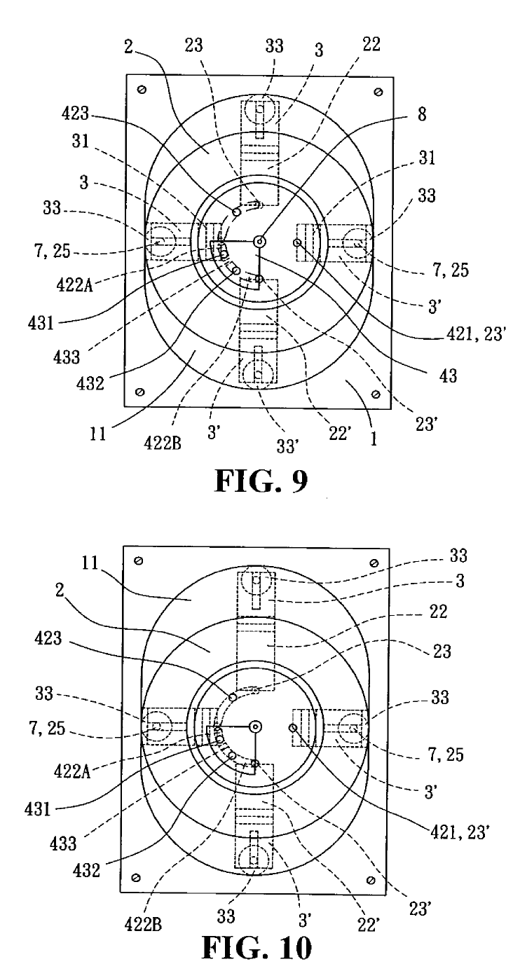

Referring to FIG. 9, in a practical application, the cylinder body 2 may be provided with four bores 22, 22′ and corresponding pistons 3, 3′, which are arranged in two groups of two bores that are opposite to each other. With the increased numbers of the bores 22, 22′ and pistons 3, 3′, the power output of the engine is increased, but the operation principle and process of the engine are not altered.

Also referring to FIG. 10, in a different application, the elliptic configuration of the track recess 11 of the cylinder seat 1 can be expanded in the major axis thereof so that the power stroke of the track recess 11 is lengthened. In this way, the time period that the piston 3 drives the cylinder body 2 to rotate is increased, thereby increasing the power output of the cylinder body 2 and an improved rotational force being provided.

Further, the engine of the present invention is driven by using two fuels, which, in a practical application, can include edible oil (such as salad oil). Since the edible oil has a higher ignition point, making it difficult to ignite, and also has a specific weight greater than gasoline, to take into consideration of the engine output power and the intake ratio between the edible oil (salad oil) and gasoline, the partition tab 433 of the regulation plate 43 is constructed to be movable along the intake channel 422 to change the amounts of space of the two sub-channels 422A, 422B for controlling the intake ratio of the fuels. In a practical application of the present invention, volumes or internal spaces of the sub-channels 422A, 422B are set to provide an intake ratio of 30% to 70%.

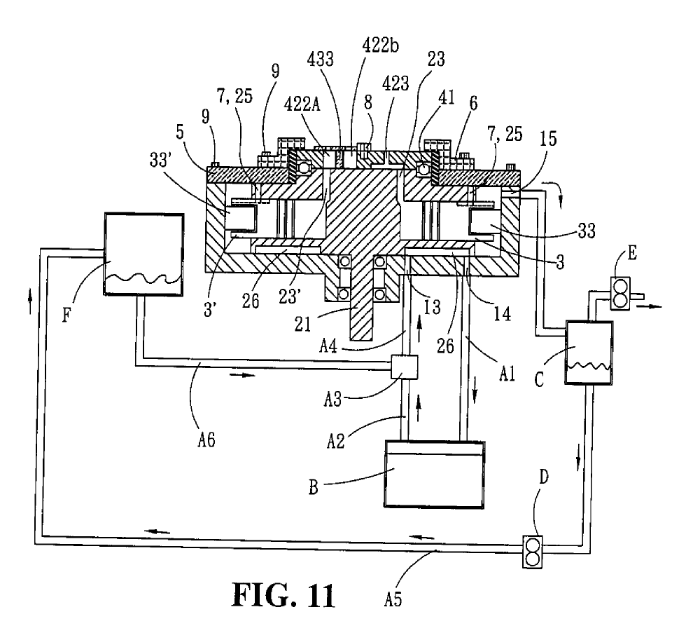

Referring to FIG. 11, in the practice of the present invention, the drain hole 15 is formed in the circumferential wall that delimits the track recess 11 at a location close to the top opening. The drain hole 15 is connected, via a pipe, to a liquid/gas separator C that is in turn connected to a liquid fuel pump D and a gas pump E. Liquid fuel residual and gaseous fuel that are spread within the whole track recess 11 and the cylinder body 2 can be drawn into the liquid/gas separator C in which the liquid component and the gaseous component are separated from each other. The gaseous component is expelled by the gas pump E, while the liquid component is expelled by the liquid pump D. Besides functioning to expel the liquid fuel residual and the gaseous fuel, the liquid pump D and the gas pump E also help the pistons 3 to bring the rollers 33 thereof to tightly abut against the elliptic track surface of the track recess 11 to facilitate the rolling thereof. The fuel pump D is externally connected to a fuel storage tank F through a discharge pipe A5, and the fuel storage tank F is further connected to a pipe A6 of which an opposite end is connected to a terminal of a reversal-flow-prevention fitting A3, whereby the fuel liquid contained in the fuel storage tank F is allowed to flow through the pipe A6 to the reversal-flow-prevention fitting A3. The fuel entering the reversal-flow-prevention fitting A3 is further guided by a pipe A4 to flow through the in-flow opening 13 and entrains a cooled liquid that flows from the out-flow opening 14 through a heat dissipation device B to get into the track recess 11 for effecting cooling. As such, a circulation loop that recycles and reuses the cooling liquid is provided.

Thus, the bottom of the track recess 11 forms the in-flow opening 13 and the out-flow opening 14 both extending therethrough. The out-flow opening 14 is externally connected to a pipe Al that has an opposite end connected to the heat dissipation device B to allow the liquid drained through the out-flow opening 14 to flow to the heat dissipation device B for heat dissipation and cooling. The cooled liquid is then supplied through an outlet pipe A2 of the heat dissipation device B and flows through the reversal-flow-prevention fitting A3 to be further guided by the pipe A4 into the in-flow opening 13, whereby the liquid can be returned back into the interior of the track recess 11 to allow the liquid drained from the out-flow opening 14 and cooled by the heat dissipation device B to be recycled through the in-flow opening 13 for re-use.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multiple-fuel rotary engine comprising a cylinder seat, a rotatable cylinder body, pistons, an intake/exhaust regulation module, a cover, and a top lid, wherein:
the cylinder seat forms a substantially elliptic recess having an elliptic side surface defining an elliptic track and has a bottom defining centrally a through hole for receiving a shaft therein, the bottom forming an in-flow opening and an out-flow opening, a drain hole extending to outside and defined through a circumferential wall that delimits the track recess;
the cylinder body is substantially cylindrical and forms the shaft received in the through hole defined in the track recess, the cylinder body having a circumference in which two circular bores that are set in proper locations and extend horizontally outward along parallel horizontal axes to be substantially corresponding to each other for respectively and movably receiving the pistons therein, each bore forming a gas hole extending through top side wall thereof, the gas holes being movable with rotation of the cylinder body to selectively communicate with an ignition opening and intake and exhaust channels defined in the intake/exhaust regulation module, each bore also forming, in the top wall thereof at a location close to an outer end of the bore, a retention hole that receives and retains a bolt extending downward into a guide slot defined in a top side surface of a piston associated with the bore;
each piston forms a plurality of circumferential airtight sealing strips on an inner end portion thereof and a horizontal recess in an outer end portion thereof, the recess receiving therein a horizontal roller, the top side surface of the piston defining the guide slot above the recess of the piston;
the intake/exhaust regulation module comprises a bearing-based seat, a gas communication seat, a regulation plate, and an airtight sleeve, the bearing-based seat being fit over a circumference of a raised cylindrical block of the cylinder body, the gas communication seat being set on the bearing-based seat and having a top wall defining therethrough the ignition opening and also forming the intake channel that is arc in shape and the exhaust channel, the gas communication seat also defining in a center of the top wall thereof an inner-threaded hole that receives and engages a bolt to attach the regulation plate to the gas communication seat, the regulation plate having a sector shape corresponding to and shielding the intake channel, the regulation plate forming two through holes and a partition tab that is provided at a bottom surface of the regulation plate between the through holes for being vertically fit into and snugly engageable with the intake channel to divide the intake channel into two sub-channels, the airtight sleeve being fit around an outer circumference of the raised cylindrical block of the cylinder body;
the cover is secured to the top of the cylinder seat by bolts and forms a central hole that receives the airtight sleeve therein with the top lid further secured thereto; and
the top lid is secured to the hole of the cover by bolts and forms a vertically extending hollow cylindrical portion that has an inward flange depressing and fixing top surfaces of the gas communication seat and the airtight sleeve;
wherein the cylinder body is rotatable within the elliptic track recess with the pistons moving along the elliptic side surface of the track recess by means of the rollers thereof and the partition tab of the intake/exhaust regulation module divides an internal space of the intake channel into the two sub-channels having volumes variable with movement of the partition tab to adjust intake ratio between two mixtures of air and two different fuels that are fed into the bores for generation of explosion energy to drive the pistons outwards, causing rotation of the cylinder body to complete a cycle of intake, compression, power, and exhaust strokes, whereby a multiple-fuel rotary engine that has a simple construction and operates on two different fuels is provided.

2. The multiple-fuel rotary engine according to claim 1, wherein the cylinder body forms in an undersurface thereof a plurality of radially-extending grooves, a through hole being defined in the grooves at a location corresponding to each bore.

3. The multiple-fuel rotary engine according to claim 1, wherein the gas communication seat forms in a bottom surface thereof an arc recess that extends upwards and has an inside top surface from a center of which a circular hole is formed and further extends upward through the gas communication seat to define, as a whole, the exhaust channel, wherein the arc intake channel and the arc exhaust channel are set in such a way to form, together, a semi-circular arrangement that corresponds to a circular path along which the two gas holes of the cylinder body move to effect intake and exhaust.

4. The multiple-fuel rotary engine according to claim 1, wherein by loosening the bolt that attaches the regulation plate to the gas communication seat, the regulation plate is rotatable with respect to the gas communication seat to vary the internal volumes of the two sub-channels to adjust the intake ratio between the two mixtures of air and two different fuels that are fed into the bores through the two sub-channels.

5. The multiple-fuel rotary engine according to claim 1, wherein the regulation plate defines two through holes, which are externally and respectively connectable with two fuel supply systems that supply edible oil and gasoline.

6. The multiple-fuel rotary engine according to claim 1, wherein the bottom of the track recess forms the in-flow opening and the out-flow opening both extending therethrough, the out-flow opening being externally connected to a pipe that has an opposite end connected to a heat dissipation device to allow the liquid drained through the out-flow opening to flow to the heat dissipation device for heat dissipation and cooling, the cooled liquid being then supplied through an outlet pipe of the heat dissipation device and flows through a reversal-flow-prevention fitting to be further guided by a pipe into the in-flow opening, whereby the liquid can be returned back into the track recess to allow the liquid drained from the out-flow opening and cooled by the heat dissipation device to be recycled through the in-flow opening for re-use.

7. The multiple-fuel rotary engine according to claim 1, wherein the drain hole that is formed in the circumferential wall that delimits the track recess at a location close to the top opening is connected, via a pipe, to a liquid/gas separator that is in turn connected to a liquid fuel pump and a gas pump.
